(19) United States
(12) Patent Application Publication
(10) Pub. No.: US 2006/0190608 A1
(43) Pub. Date: Aug. 24, 2006

(54) Method for the obtaining of deployment components to electronic devices

(75) Inventors: Mikko Sahinoja, Tampere (FI); Eero Kaappa, Tampere (FI); Janne Vento, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/061,088

(22) Filed: Feb. 18, 2005

(51) Int. Cl. G06F 15/16

(52) U.S. Cl. 709/227

(57) ABSTRACT

In a method for the delivery of deployment components to an electronic device, a management session is set-up between the electronic device and a server. The electronic device receives a location for a deployment component from the server. A target state is received for the deployment component in the electronic device from the server. A place for a management object representing the deployment component in a management object data structure is determined in the electronic device based on the target state. The deployment component is downloaded in the electronic device from the location.

### BACKGROUND OF THE INVENTION

1. Field of the invention

The invention relates to device management. Particularly, the invention relates to a method for the obtaining of deployment components to electronic devices.

2. Description of the Related Art

As different data processing devices, such as mobile stations, become more complex, the significance of device management becomes more pronounced. Devices require several different settings, such as settings related to Internet access points, and setting them manually by the user is arduous and difficult. To solve this problem, for instance, device management solutions have been developed so that the administrator of a company's information system or a network operator can set an appropriate configuration for a device. Device management generally refers to actions by which a person typically not using a device can change the configuration of the device; for instance change the settings used by the device. In addition to device-specific settings, it is also possible to transmit user-specific data, such as user profiles, logos, ringing tones, and menus with which the user can personally modify the settings of the device, or the modification takes place automatically in connection with device management.

One of the device management standards is Open Mobile Alliance (OMA) Device Management (DM), which is partly based on the Synchronization Markup Language (SyncML) protocol. The principles of OMA device management protocol are disclosed in the OMA specification “OMA Device Management Protocol”, Draft Version 1.2, January 2005, OMA-DM-Protocol-V1_{—}2_{—}0-20050125-D. For instance, a Personal Computer (PC) can act as a device management server in a device management protocol and a mobile station as a device management client. A network operator may also host the device management server. In terms of device management, the device management client, possibly on the basis of a triggering message from the device management server, transmits information concerning itself in a session initiation message to the device management server, and the device management server replies by transmitting management commands. The device management client replies to these with status information, after which the server can end the session or transmit more management commands. If the server transmits more management commands, the client is to reply to them with status information. The server can always, after receiving status information, end the session or continue it by transmitting more management commands. Device management can also be implemented by first transmitting queries to the user about what she wishes to update, and information on the user's selections is transmitted to the server. Next, the server can in the next packet transmit the updates/commands the user desires.

Reference is now made to FIG. 1, which illustrates the exemplary logical OMA device management architecture in prior art. In FIG. 1 there is a Mobile Terminal (MT) 100, in other words, a mobile hand-set. The mobile terminal communicates with a network 110, which comprises at least a base station 120. To network 110 is connected a DM server 130. It should be noted that OMA DM is transport agnostic. This means that a connection between a client and a server may be based on any transmission technology. For example, fixed connections and local short-range radio connections are as well possible.

The DM server manages information in mobile terminal 100. The information to be managed comprises settings utilized by native applications, telecommunication services such as General Packet Radio Service (GPRS) and supplementary services in mobile terminal 100. The information to be managed also comprise down-loadable software components, the settings associated with them and the software component states, that is, whether they are enabled for execution or disabled. The information to be managed can be perceived as managed objects. The information to be managed is stored by mobile terminal 100 in its memory according to a structure, which is optimized for the operation of mobile terminal 100. However, the information is made available by mobile terminal 100 as a management information data structure, which is intended to provide an organized view on the managed objects.

In FIG. 1 there is a box 102, which illustrates the internal functions of mobile terminal 100. Mobile terminal 100 comprises a native Operating System (OS) environment, which performs a variety of operating system services such as process scheduling, memory management and file system management. Mobile terminal 100 comprises also storage 154 for managed objects. Storage 154 consists of memory available for the managed objects in mobile terminal 100. The memory may comprise consecutive or non-consecutive blocks of memory. In storage 154 there are illustrated three managed objects, namely, an object A 160, an object B 162 and an object C 164. The managed objects are organized in the memory of mobile terminal 100 in an arbitrary fashion. In FIG. 1 there is also a DM agent 150, which processes management requests issued from the DM server 130. DM agent 150 processes management messages sent to and received from DM server 130. DM agent 150 organizes the managed objects as a tree structure 152. Tree structure may be called a management information tree. Tree structure 152 provides an organized view to the managed objects stored in arbitrary order in storage 154. The tree structure 152 is made available to DM server 130, which perceives each managed object as a node in tree structure 152. Tree structure comprises interior nodes such as node 156 and 158, which provide a grouping of managed objects, and nodes for the managed objects themselves. Objects A, B and C are represented in tree structure 152 as nodes 170, 172 and 174, respectively. Nodes in tree structure are addressed using Internet Uniform Resource Identifiers (URIs). The tree structure can be perceived as an Extensible Mark-up Language (XML) document wherein the nodes are document elements. In some cases there may be a direct correspondence between the location of managed object in the tree structure and the location of the managed object in storage 154. For example, there may be nodes corresponding to specific directories in the file system of mobile terminal 100.

Management sessions may be set-up between mobile terminal 100 and DM server 130. During a management session DM server 130 may typically send a management request 140, which identifies at least an operation and the URI for the target node. Nodes may be, for example, added, replaced, deleted, read and executed. A node may comprise text, binary data and actions to be executed by mobile terminal 100. In response to management request 140, mobile terminal 100 provides a management response, which comprises status indicating success or failure of the operation and returned result data.

Reference is now made to FIG. 2, which illustrates the OMA device management protocol operation in prior art. In FIG. 2 there is a DM client 200, which may be, for example, mobile terminal 100 as illustrated in FIG. 1. There is also a DM server 130, which engages in a management session with DM client 200. In FIG. 2 the commands exchanged in a management session are illustrated. DM client 200 initiates the management session by sending a package 201. A package is a conceptual set of commands that could be spread over multiple messages. A message is an atomic unit in the OMA DM protocol. It is one packet that the bearer network is able to accept. One package could be divided in many messages. A package comprises a synchronization header (SyncHdr) and a synchronization body (SyncBody). Synchronization body comprises at least one command. The packages are structured according to XML documents. The commands are XML elements in the document.

In package 201 there is a synchronization header, a synchronization body comprising an Alert 1201 command, a Replace command and a Final element. Alert 1201 command indicates that it is question of a client initiated management session. In the Replace command DM client 200 provides its device properties to the DM server 130. The Replace command indicates that the device has replaced the management objects associated with the device properties to correspond the current device configuration. For example, external adjunct devices such as a external display may have been connected to DM client 200 since latest device property indication. The device properties may be used, for example, in the selection of correct versions of software components, documents and multimedia presentations to be downloaded during the management session. DM server 130 responds by sending a package 202 to DM client 200.

Package 202 comprises a synchronization body, which further comprises three Status commands indicating the successful delivery and processing of synchronization header, the Alert command and the replace command, and a command sequence, which further comprises an Alert 1101 command for providing to the user a prompt text and an Add command for adding a new node for a managed object to the tree structure held by DM client 200, and Final element. Success is indicated with value 200 that is carried in the data element of the Status command. DM client 200 provides the response to package 202 by sending a package 203.

Package 203 comprises a synchronization body, which further comprises four Status commands indicating the successful delivery and processing of synchronization header, the command sequence, the Alert command and the Add command, and a Final element. The success of Alert 1101 command indicates that the user has accepted the management action further explained in the prompt text. Had the user not accepted the management action, DM client 200 would have interrupted the command sequence.

In response to the receiving of package 203, DM server 130 sends a package 204, which comprises a Status command for synchronization header and a Final element. Package 204 acknowledges the status of DM client 200. After receiving package 204 DM client 200 does not continue the protocol.

In OMA document “Firmware Update Management Object” (OMA-DM-FUMO-V1_{—}0_{—}0-20050131-D), draft version 1.0, Jan. 31st, 2005, describing the updating of firmware objects there is described a method where the state of a firmware update package may be changed using commands issued by a DM server. The firmware update package traverses through a number of states depending on whether the downloading is progressing, whether the download has been completed, whether the update is in progress and whether the update has been successful or whether it has failed. The problem associated with the solution disclosed in the document is that the state machine for firmware updates is hard-coded in the protocol. For each new state transition to be added for packages, a new operation node must be added to the management object tree. For the new node will then be sent an execution command by the DM server in order to fulfill the state transition. Thus, the OMA DM standard must be updated every time a new possible state is observed in firmware updating process. It is not possible to determine target states dynamically based on values provided from the DM server, which makes the protocol inextensible.

Reference is now made to FIG. 3, which illustrates management objects associated with deployment components organized using the teachings from the prior art. The deployment components are software components stored in a mobile terminal such as mobile terminal 100 in FIG. 1. The software components may have been provided to mobile terminal using Hypertext Transfer Protocol (HTTP), File Transfer Protocol (FTP) or by using a carrier such as a memory card. The management objects associated with deployment components are assembled under an interior node 300. There is a node 310, which represents an inventory of deployment components. The components that have merely been delivered are organized under node 313. The components already deployed in mobile terminal 100 are organized under a node 311. Under node 311 there is at least one node 312. Each at least one node 312 represents a deployment component that has been deployed. For a deployed deployment component there are nodes that store the identifier of the component (ID), component name, component version and the state of the component. The state indicates whether the component is active or inactive. Under node 313 there is at least one node 314. Each at least one node 314 represents a deployment component that has been delivered. For a delivered deployment component there are nodes that store the identifier of the component, component name, component version, component binary code (data), installation options and a descriptor.

There is also a node 320, under which are assembled the nodes for the operations for the deployment components under node 311 or 313. The operations comprise: Install, Remove, Update, Activate 322, Deactivate 323 and InstallAndActivate 324. For example, for activating a deployment component under node 311, DM server 130 sends in a package an Execute command. The Execute command specifies in the target element the location URI for node 322 and in the data element the correct deployment component URI. Respectively, for deactivating a deployment component under node 311 an execute command specifies in the target element the location URI for node 323.

There is also a node 330, for which an Execute command may be requested by DM server 130 in order to download a deployment component to mobile terminal 100. There is a URI node 331 for specifying the deployment component location information for downloading. There are also nodes for status, deployment component identifier, deployment component name and version that are filled by mobile terminal 100 after the downloading of the deployment component. In order to download a deployment component DM server 130 sends an Add command for adding the URI value. The Add command comprises the desired URI value. Thereupon, DM server 130 sends an Execute command, which specifies in the target element the URI for node 330. In response mobile terminal 100 performs the downloading of the deployment component specified in node 331.

The problem associated with the organization of deployment components in prior art is that a deployment component must be first downloaded and placed under the node for delivered components. Thereupon, by executing an activation node, the software component must be separately activated, which causes the transfer of the deployment component under the node for deployed components. The result is that a deployment component has to be stored twice in the mobile terminal memory. This may be unacceptable due to limited memories available in mobile terminals. The two-phase model of installation increases messaging traffic between mobile terminals and DM servers, which in turn delays the installation of deployment components to be activated.

### SUMMARY OF THE INVENTION

The invention relates to a method for the obtaining of deployment components to an electronic device. The method comprises: setting-up a management session between the electronic device and a server; receiving in the electronic device a location for a deployment component from the server; receiving a target state for the deployment component in the electronic device from the server; determining the place for a management object representing the deployment component in a management object data structure in the electronic device based on the target state; and downloading the deployment component in the electronic device from the location.

The invention relates to a method for the obtaining of deployment components to an electronic device, the method comprising: setting-up a management session between the electronic device and a server; receiving in the electronic device a location for a deployment component from the server; receiving a target state for the deployment component in the electronic device from the server; downloading the deployment component in the electronic device from the location; and determining the place for a management object representing the deployment component in a management object data structure in the electronic device based on the target state.

The invention also relates to a method for the delivery of deployment components to an electronic device, the method comprising: forming in a server a first command that comprises a location; forming in the server a second command that comprises a target state; forming in the server a third command that indicates a node for triggering the downloading of a deployment component; and sending the first, second and third commands in at least one package from the server to the electronic device.

The invention also relates to an electronic device comprising: a device management agent configured to set-up a management session between the electronic device and a server, to receive a location for a deployment component from the server, to receive a target state for the deployment component from the server, to determine the place for a management object representing the deployment component in a management object data structure in the electronic device based on the target state; and a communication entity configured to download the deployment component from the location.

The invention also relates to a server comprising: a device management entity configured to set-up a management session between an electronic device and the server, to provide a location for a deployment component to the electronic device, to provide a target state for the deployment component to the electronic device, to issue an execution request associated with a management object referring to the downloading of the deployment component.

The invention relates also to a computer program comprising code adapted to perform the following steps when executed on a data-processing system: setting-up a management session to a server; receive a location for a deployment component from the server; receiving a target state for the deployment component from the server; determining the place for a management object representing the deployment component in a management object data structure based on the target state; and downloading the deployment component from the location.

The invention relates also to a computer program comprising code adapted to perform the following steps when executed on a data-processing system: setting-up a management session between an electronic device and a server; providing a location for a deployment component to the electronic device; providing a target state for the deployment component to the electronic device; and issuing an execution request associated with a management object referring to the downloading of the deployment component.

The invention relates also to a computer program comprising code adapted to perform the following steps when executed on a data-processing system: setting-up a management session to a server; receive a location for a deployment component from the server; receiving a target state for the deployment component from the server; downloading the deployment component from the location; and determining the place for a management object representing the deployment component in a management object data structure based on the target state.

In one embodiment of the invention, the downloading of the deployment component, or the initiating of the downloading of the deployment component, in the electronic device from the location is performed before the determining step, wherein the place for a management object representing the deployment component in a management object data structure is determined in the electronic device based on the target state. In one embodiment of the invention, the place for the management object is determined before the downloading of the deployment component.

In one embodiment of the invention, the electronic device is a mobile terminal, which acts as an Open Mobile Alliance (OMA) Device Management (DM) client. The device management agent is an entity executed in the mobile terminal, which sends device management commands to the server and receives device management commands from the server. The device management entity maintains a management object data structure, which may be, for example, a management information tree.

In one embodiment of the invention, the server is a device management server, for example, an OMA DM server. The server comprises a device management entity, which performs the device management related tasks in the server. The device management entity may be a software component or a set of software components that are responsible for the device management tasks according to the invention.

In one embodiment of the invention, a node name for the deployment component is received in the electronic device from the server and the name for the management object is set based on the node name in the electronic device.

In one embodiment of the invention, a node name for the management object is determined in the electronic device and the node name for the management object is indicated from the electronic device to the server. The indication may be carried in an Alert command for a node representing the node name for the deployment component.

In one embodiment of the invention, the location and the target state are stored in a management information tree in the electronic device. The management session is ended before the downloading. The location and the target state are provided from the management information tree to an indirect delivery entity in the electronic device, and the downloading is performed by the indirect delivery entity.

In one embodiment of the invention, in the server is formed a first command that comprises the location. In the server is also formed a second command that comprises the target state. In the server is also formed a third command that indicates a node for triggering the downloading of the deployment component. The first, second and third commands are sent in at least one package from the server to the electronic device. The commands are formed in a device management entity in the server. The device management entity sends the first, second and third commands in at least one package to the electronic device.

In one embodiment of the invention, the location comprises a Uniform Resource Identifier (URI). In one embodiment of the invention, a Uniform Resource Identifier (URI) specifies the place of the management object in the management object data structure.

In one embodiment of the invention, the electronic device is at least one of a General Packet Radio System terminal, a Universal Mobile Telecommunications System terminal and a Wireless Local Area Network terminal.

In one embodiment of the invention, the computer program is stored on a computer readable medium. The computer readable medium may be a removable memory card, magnetic disk, optical disk or magnetic tape.

In one embodiment of the invention, the electronic device is a mobile device, for example, a laptop computer, a palmtop computer, a mobile terminal or a personal digital assistant (PDA). In one embodiment of the invention, the electronic device is a desktop computer or a mainframe computer.

The benefits of the invention are related to the increased efficiency in the delivery of deployment components to the electronic device. The management session duration can be reduced. The invention also avoids the storing of the same deployment component twice in the electronic device memory, which enables devices with smaller memories to be used to store large deployment components.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram, which illustrates the OMA device management architecture in prior art;

FIG. 2 is a message sequence chart, which illustrates the OMA device management protocol operation in prior art;

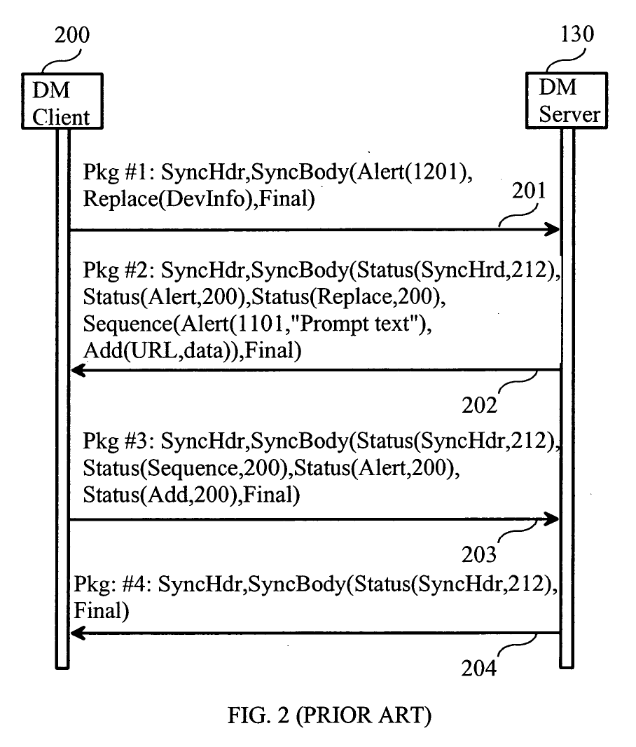

FIG. 3 is a block diagram, which illustrates management objects associated with deployment components in prior art;

FIG. 4 is a block diagram, which illustrates management objects associated with deployment components, in one embodiment of the invention;

FIG. 5 is a message sequence chart, which illustrates the use of OMA device management protocol, in one embodiment of the invention;

FIG. 6 is a flow chart illustrating a deployment component delivery method, in one embodiment of the invention; and

FIG. 7 is a block diagram illustrating an electronic device according to the invention.

### DETAILED DESCRIPTION OF THE EMBODIMENTS

Reference will now be made in detail to the embodiments of the present invention, examples of which are illustrated in the accompanying drawings.

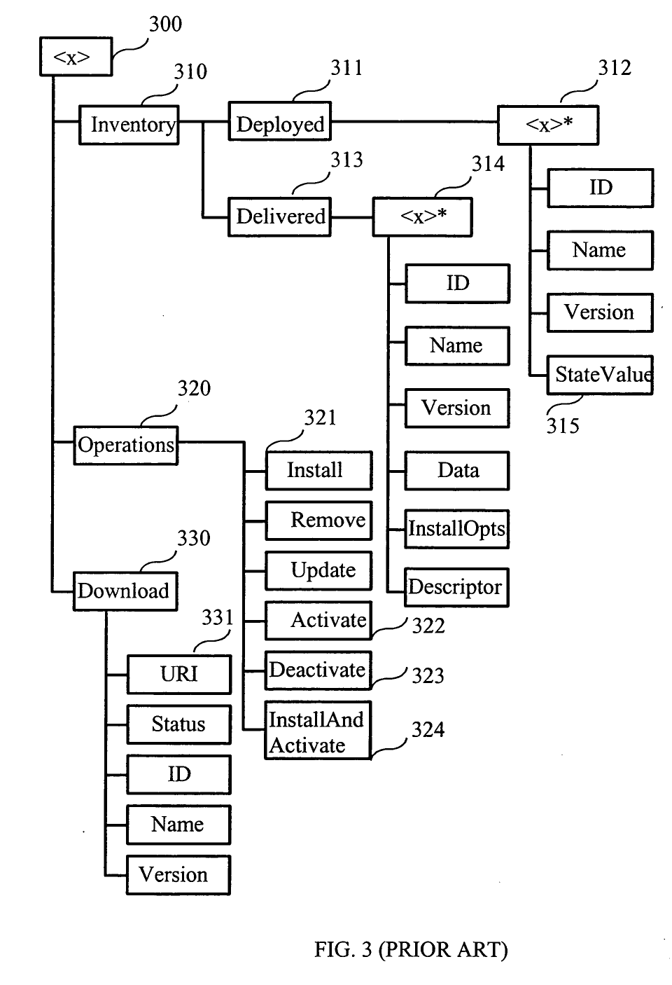

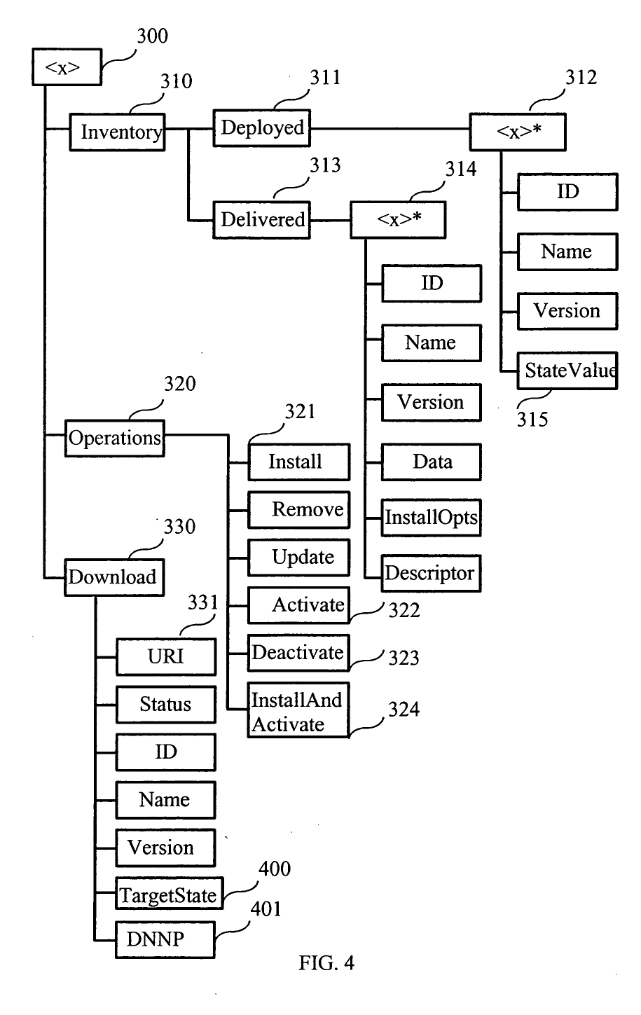

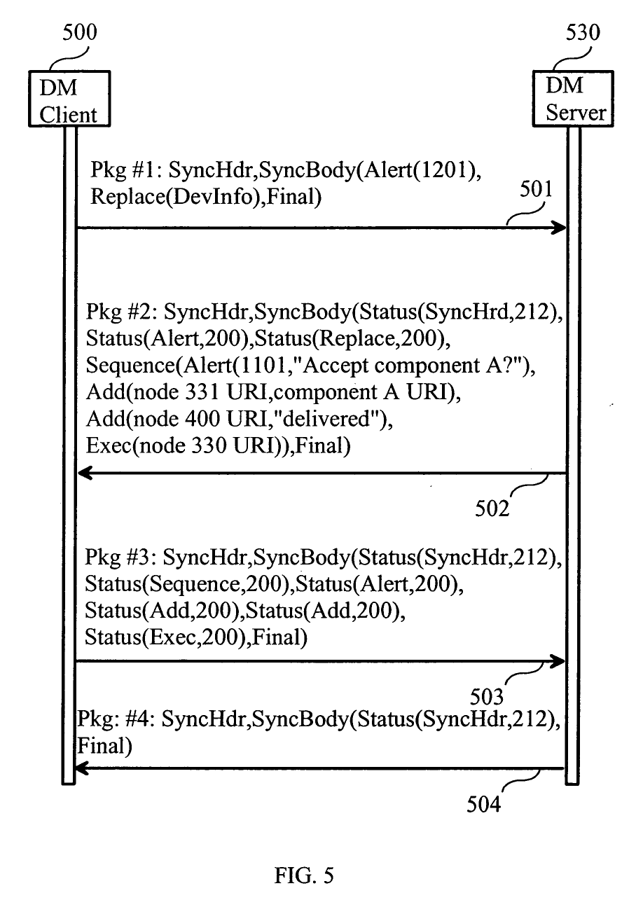

FIG. 4 is a block diagram, which illustrates management objects associated with deployment components in one embodiment of the invention. The management objects are managed, for example, using OMA device management protocol as illustrated in FIG. 5. The device management commands are sent between a DM client 500 and DM server 530 as illustrated in FIG. 5. DM client 500 represents a mobile station such as mobile station 100. In FIG. 4 there is a node 310 for deployment component inventory and a node 320 for the deployment component operations with the respective sub-trees as illustrated in FIG. 3. There is also a node 330 for triggering the download of a deployment component, that is, on which DM server 530 may impose an Execute command in order to download the deployment component to DM client 500. There is a URI node 331 for specifying the deployment component location information for downloading. There are also nodes for status, deployment component identifier, deployment component name and version that are filled by DM client 500 after the downloading of the deployment component. In addition to the nodes familiar from FIG. 3, in FIG. 4 there are two new nodes. There is a node 400, which stores a target state for the deployment component identified with the URI in node 331. DM server 530 may insert a value to the target state. The value will indicate to DM client 500 the correct handling for the deployment component after the downloading of it has been triggered. DM client 500 will check the target state value. For example, if the target state has values such as “install” or “update”, a node for deployment component must be placed under node 311. Similarly, if the deployment component target state has the value active, the deployment component must be activated under the native operating system within DM client 500. The state value node 315 will indicate, using values active and inactive whether the deployment component has been activated or whether it remains inactive. Further, if the target state has the value delivered, a node for deployment component must be placed under node 313.

In FIG. 4, there is also a node 401, which is named as Dynamic Node Name Proposal (DNNP). The name could, of course, be something else. The name is just selected for the purpose of illustration. Prior to triggering the download, DM server 530 adds a value to node 401 to indicate what name is desired for the interior node representing the deployment component. The interior node representing the deployment component will be put under either node 311 or 313 depending on the target state value.

FIG. 5 is a message sequence chart, which illustrates the use of OMA device management protocol in one embodiment of the invention. In FIG. 5 there is a DM client 500 and a DM server 530. DM client 500 is in an electronic device, for example, a mobile terminal such as mobile terminal 100. The DM client 500 may comprise a DM agent, which receives and sends commands on behalf of the native operating system environment. DM agent may receive indications from native operating system on conditions that cause commands and messages to be sent by DM agent. Similarly, in response to commands from DM server 530, DM agent may provide indications to the native operating system environment that cause a variety of operating system services to be invoked. In FIG. 5 there is illustrated the downloading of a deployment component A to DM client 500 and the further processing of component A in terms of the target state and node name, in one embodiment of the invention.

DM client 500 initiates the management session by sending a package 501. In package 501 there is a synchroniprising an Alert 1201 command, a Replace command and a Final element. Alert 1201 command indicates that it is question of a client initiated management session. In the Replace command DM client 500 provides its device properties to the DM server 530. The Replace command indicates that the device has replaced the management objects associated with the device properties to correspond the current device configuration. DM server 530 responds by sending a package 502 to DM client 500.

Package 502 comprises a synchronization body, which further comprises three Status commands indicating the successful delivery and processing of synchronization header, the Alert command and the replace command, and a command sequence, which further comprises an optional Alert 1101 command for providing to the user the prompt text for accepting deployment component A, an Add command for adding the URI of deployment component A to node 331, an Add command for adding the value “delivered” to node 400 representing target state, an Execute command specifying node 330 URI that triggers the downloading of deployment component A to DM client 500, and Final element. In response to package 502 DM client 500 checks the download URI for component A from node 331. DM client 500 also checks whether deployment component A should be classified as delivered or deployed and whether the interior node that represents deployment component A should be placed under node 311 or node 313. Thereafter, DM client downloads deployment component A and places the interior node that represents deployment component A under node 313, because node 400 has the value “delivered”.

DM client 500 provides the response to package 502 by sending a package 503. Package 503 comprises a synchronization body, which further comprises six Status commands indicating the successful delivery and processing of synchronization header, the command sequence, the Alert command, the two Add commands, the Execute command, and a Final element. The success of Alert 1101 command indicates that the user has accepted the management action further explained in the prompt text. Had the user not accepted the management action, DM client 500 would have interrupted the command sequence.

In response to the receiving of package 503, DM server 530 sends a package 504, which comprises a Status command for synchronization header and a Final element. Package 504 acknowledges the status of DM client 500. After receiving package 504 DM client 500 does not continue the protocol.

However, it should be noted that as DM server 530 issues an Execute command on an operation branch such as a branch for indicating download, a status is returned by DM client 500 in next package. The status does, however, not indicate the completion of the operation such as download. The status only indicates that DM client 500 has started processing the operation. If the mere starting of the operation fails, DM client returns a failure status. As soon as the entire operation is complete, the success is indicated in an asynchronic manner to DM server 530. If there is an active management session, the success of the entire operation is indicated using generic alert. If there is no session, DM client 500 establishes it. The generic alert is associated to the Execute command using a correlation value.

In one embodiment of the invention, node 401 is not used to provide the name for the interior node representing the deployment component or DM client 500 may alter the name provided. In this case the name will be indicated to DM server 530 so that, for example, in package 503 is sent an Alert command, which reveals the name to DM server 530.

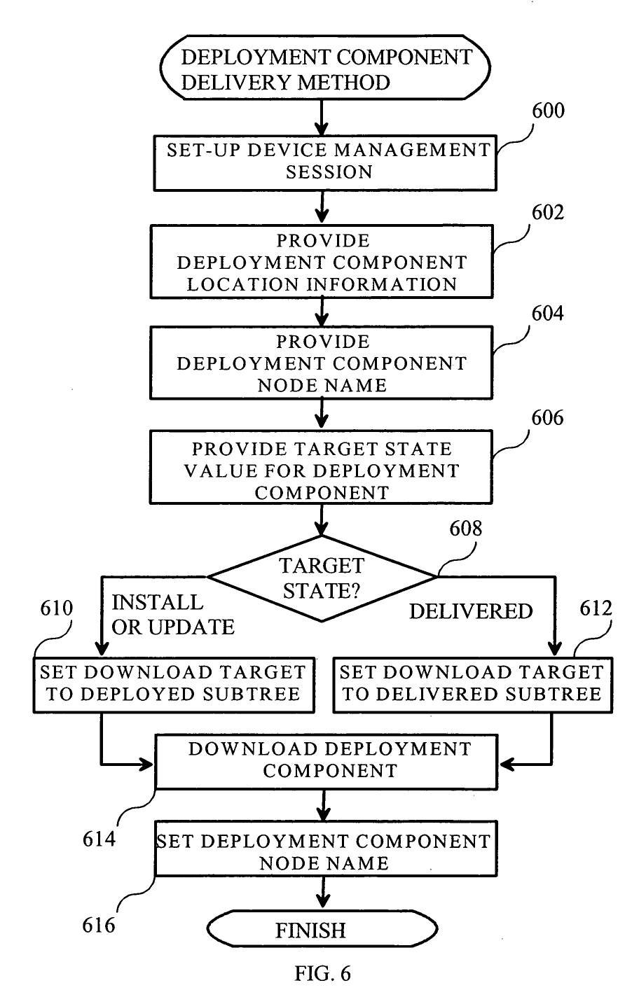

FIG. 6 is a flow chart illustrating a deployment component delivery method in one embodiment of the invention. In one embodiment of the invention, the protocol used is as illustrated in FIG. 5. In one embodiment of the invention, the data structure for storing information on managed objects is as illustrated in FIG. 4. The data structure comprises nodes for representing managed objects and their properties.

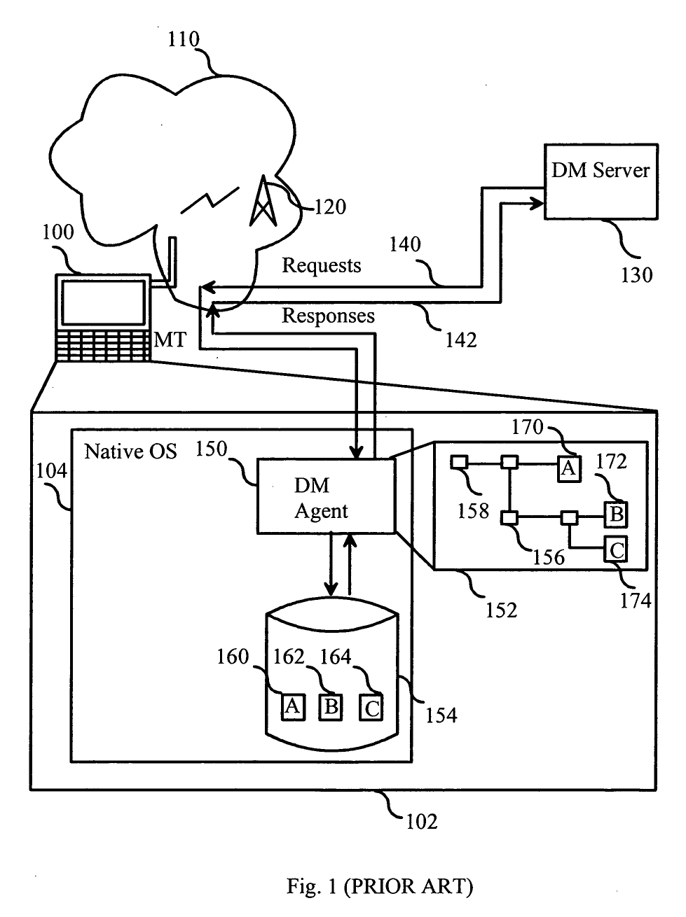

At step 600 a Device Management (DM) session is set-up between a DM client and DM server. The device management session may be set-up by DM client due to a condition detected by DM client independently or due to an alert notification received from DM server. As a result of the DM session the DM server and DM client may exchange commands. The management session may be handled in DM client in a DM agent such as DM agent 150 in mobile terminal 100 of FIG. 1.

At step 602 DM server provides to DM client information on the location of a deployment component. The location of the deployment component may be, for example, a Uniform Resource Identifier (URI). The location of the deployment component may be provided so that a value is attached to a node for storing the location.

At step 604 DM server provides to DM client a node name for the deployment component. The node name of the deployment component may be provided so that a value is attached to a node for storing the proposed name. It should be noted that step 604 is omitted in one embodiment of the invention. Thus step 604 is optional.

At step 606 DM server provides to DM client a target state value for the deployment component. The target state value of the deployment component may be provided so that a value is attached to a node for storing the target state. In one embodiment of the invention, the DM session may be terminated after the DM client has acknowledged the receipt of the information provided by the DM server. In this embodiment the actual downloading of the deployment component may be performed indirectly using another delivery channel, for example, using Hypertext Transfer Protocol (HTTP) or delivery via a carrier such as a memory card.

At step 608 DM client checks the value attached to the target state node 400. If the target state value is “install” or “update”, download target is set to be the sub-tree for deployed deployment components at step 610. If the target state value is “delivered”, download target is set to be the sub-tree for delivered deployment components at step 612. The mentioned sub-trees may be represented in DM client file system as separate folders or files. The subtrees may also have separate memory buffers in case the sub-trees are not represented as primary memory structures.

At step 610 DM client downloads the deployment component. The downloading is performed to the download target as designated at step 610 or at step 612. The downloading of the deployment component may be triggered by DM server by issuing an execute command to DM client, which command designates a node representing the downloading of deployment components using the parameters earlier provided. For example, node 330 is such a node.

At step 612 DM client sets the node name for the node representing the downloaded deployment component. The node representing the downloaded deployment component may be among the at least one node 312 or among the at least one node 314. DM client may independently determine the node name or it may be the node name provided from DM server at step 604.

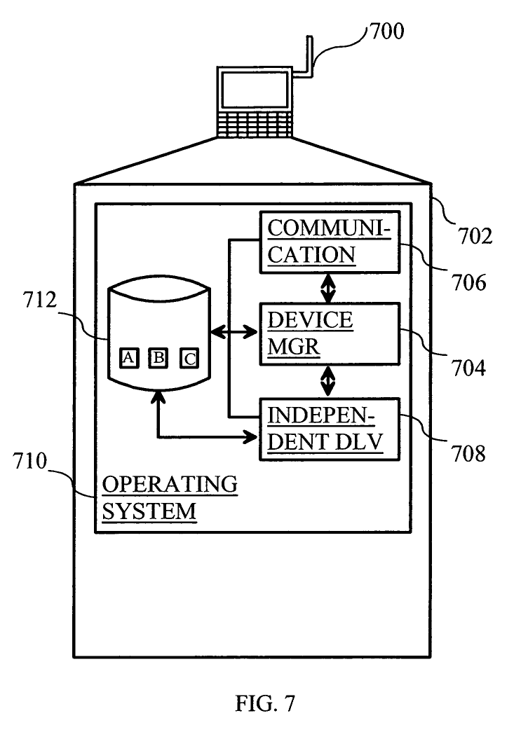

FIG. 7 is a block diagram illustrating an electronic device according to the invention. Electronic device 700 may comprise a first memory (not shown) and a second memory (not shown). The first memory is a volatile RAM work memory and the second memory is a non-volatile memory. In one embodiment of the invention the first and the second memories are the same memory, which is non-volatile. The electronic device also comprises a processor (not shown).

In FIG. 7 there is a box 702, which illustrates the software in electronic device 700. The software comprises at least an operating system entity 710, a device management agent 704 and a communication entity 706. The device management agent 704 performs the tasks of device management client 500 in FIG. 5. Device management agent 704 also comprises functionalities similar to management agent 150 in FIG. 1. Communication entity 706 performs the communication related tasks in the electronic device. It comprises the protocol stacks that are used for the radio interface communication and in the communication with a remote network such as the Internet. When communication entity 706 receives messages related to device management from a server, they are forwarded to device management agent 704. Similarly, device management commands addressed to the network server are sent from device management agent 704 via communication entity 706. Electronic device 700 may also comprise an independent delivery entity 708, which performs the downloading or obtaining of deployment components independent of device management entity 706. The communication entity performs the actual downloading of deployment components either at the request of device management agent 704 or independent delivery entity 708. Electronic device 700 also comprises a storage 712, which corresponds to storage 154 as illustrated in FIG. 1. Storage may also be in an external device connected to electronic device 700 via a wireless (like Bluetooth, WLAN) or wired connection. Storage 712 stores deployment components and the data used by management agent 704 to form the management information data structure. Independent delivery entity 708 is able to obtain data either from device management agent 704 or storage 712 in order to determine what deployment components to download.

It is obvious to a person skilled in the art that with the advancement of technology, the basic idea of the invention may be implemented in various ways. The invention and its embodiments are thus not limited to the examples described above; instead they may vary within the scope of the claims.

1. A method for obtaining deployment components to an electronic device, the method comprising:
setting-up a management session between said electronic device and a server;
receiving in said electronic device a location for a deployment component from said server;
receiving a target state for the deployment component in said electronic device from said server;
determining a place for a management object representing said deployment component in a management object data structure in said electronic device based on said target state; and
downloading said deployment component in said electronic device from said location.

2. The method according to claim 1, the method further comprising:
receiving a node name for said deployment component in said electronic device; and
setting a name for said management object based on said node name in said electronic device.

3. The method according to claim 1, the method further comprising:
determining a node name for said management object in said electronic device; and
indicating the node name for said management object from said electronic device to said server.

4. The method according to claim 1, the method further comprising:
storing said location and said target state to a management information tree in said electronic device;
ending said management session before said downloading;
providing said location and said target state from said management information tree to an indirect delivery entity in said electronic device; and
performing said downloading by said indirect delivery entity.

5. The method according to claim 1, wherein said electronic device is an Open Mobile Alliance (OMA) Device Management (DM) client and said server is a device management server.

6. The method according to claim 1, wherein a Uniform Resource Identifier (URI) specifies the place of said management object in said management object data structure.

7. A method for obtaining deployment components to an electronic device, the method comprising:
setting-up a management session between said electronic device and a server;
receiving in said electronic device a location for a deployment component from said server;
receiving a target state for the deployment component in said electronic device from said server;
downloading said deployment component in said electronic device from said location; and
determining a place for a management object representing said deployment component in a management object data structure in said electronic device based on said target state.

8. A method for delivery of deployment components to an electronic device, the method comprising:
forming in a server a first command that comprises a location;
forming in said server a second command that comprises a target state;
forming in said server a third command that indicates a node for triggering downloading of a deployment component; and
sending said first command, said second command and said third command in at least one package from said server to said electronic device.

9. An electronic device comprising:
a device management agent configured to set-up a management session between said electronic device and a server, to receive a location for a deployment component from said server, to receive a target state for the deployment component from said server, to determine a place for a management object representing said deployment component in a management object data structure in said electronic device based on said target state; and
a communication entity configured to download said deployment component from said location.

10. The electronic device according to claim 9, wherein said device management entity is further configured to receive a node name for said deployment component and to set a name for said management object based on said node name.

11. The electronic device according to claim 9, wherein said device management entity is further configured to determine a node name for said management object and to indicate said node name for said management object to said server.

12. The electronic device according to claim 9, wherein said electronic device comprises:
a device management entity configured to store said location and said target state to a management information tree, to end said management session before said download, to provide said location and said target state from said management information tree to an indirect delivery entity; and
an indirect delivery entity to perform said download.

13. The electronic device according to claim 9, wherein said electronic device is an Open Mobile Alliance (OMA) Device Management (DM) client.

14. The electronic device according to claim 9, wherein a Uniform Resource Identifier (URI) specifies a place of said management object in said management object data structure.

15. The electronic device according to claim 9, wherein said electronic device comprises at least one of a General Packet Radio System terminal, a Universal Mobile Telecommunications System terminal or a Wireless Local Area Network terminal.

16. A server comprising:
a device management entity configured to set-up a management session between an electronic device and said server,
to provide a location for a deployment component to said electronic device,
to provide a target state for said deployment component to said electronic device,
to issue an execution request associated with a management object referring to downloading of said deployment component.

17. The server according to claim 16, wherein said server is an Open Mobile Alliance (OMA) Device Management server.

18. The server according to claim 17, wherein said device management entity is further configured
to form a first command that comprises said location,
to form a second command that comprises said target state,
to form a third command that indicates the management object referring to the downloading of said deployment component, and
to send said first, second and third commands in at least one package to said electronic device.

19. A computer program comprising code adapted to perform the following steps when executed on a data-processing system:
setting-up a management session to a server;
receive a location for a deployment component from said server;
receiving a target state for the deployment component from said server;
determining a place for a management object representing said deployment component in a management object data structure based on said target state; and
downloading said deployment component from said location.

20. The computer program according to claim 19, wherein said computer program is stored on a computer readable medium.

21. The computer program according to claim 20, wherein said computer readable medium is a removable memory card.

22. The computer program according to claim 20, wherein said computer readable medium is a magnetic or an optical disk.

23. A computer program comprising code adapted to perform the following steps when executed on a data-processing system:
setting-up a management session between an electronic device and a server;
providing a location for a deployment component to said electronic device;
providing a target state for said deployment component to said electronic device; and
issuing an execution request associated with a management object referring to downloading of said deployment component.

24. The computer program according to claim 23, wherein said computer program is stored on a computer readable medium.

25. The computer program according to claim 24, wherein said computer readable medium is a removable memory card.

26. The computer program according to claim 24, wherein said computer readable medium is a magnetic or an optical disk.

27. A computer program comprising code adapted to perform the following steps when executed on a data-processing system:
setting-up a management session to a server;
receive a location for a deployment component from said server;
receiving a target state for the deployment component from said server;
downloading said deployment component from said location; and
determining a place for a management object representing said deployment component in a management object data structure based on said target state.

28. The computer program according to claim 27, wherein said computer program is stored on a computer readable medium.

29. The computer program according to claim 28, wherein said computer readable medium is a removable memory card.

30. The computer program according to claim 28, wherein said computer readable medium is a magnetic or an optical disk.
